(19) United States
(12) Patent Application Publication
(10) Pub. No.: US 2026/0080626 A1
(43) Pub. Date: Mar. 19, 2026

(54) METHOD AND APPARATUS FOR OPTIMIZING GARMENT SIMULATION PARAMETERS

(71) Applicant: CLO Virtual Fashion Inc., Seoul (KR)

(72) Inventors: Eun Jung JU, Seoul (KR); Eung June SHIM, Seoul (KR); Myung Geol CHOI, Seoul (KR)

(21) Appl. No.: 19/397,826

(22) Filed: Nov. 21, 2025

Related U.S. Application Data
(63) Continuation of application No. PCT/KR2024/007046, filed on May 24, 2024.

(30) Foreign Application Priority Data
May 24, 2023 (KR) 10-2023-0067275
May 23, 2024 (KR) 10-2024-0067046

(51) Int. Cl. G06T 17/20; G06T 3/18; G06T 19/20

(52) U.S. Cl. CPC G06T 17/20; G06T 3/18; G06T 19/20; G06T 2200/24; G06T 2210/16; G06T 2219/2021

(57) ABSTRACT

A method and device for estimating physical property parameters are disclosed. The method of estimating physical property parameters for a drape simulation of a virtual fabric includes generating a mesh by applying physical property parameters corresponding to the virtual fabric to a neural network, obtaining, based on the mesh, drape data corresponding to a type of target data related to a drape of the virtual fabric, and updating the physical property parameters based on an error between the obtained drape data and the target data.

### CROSS-REFERENCE TO RELATED APPLICATIONS

This is a bypass continuation of International PCT Application No. PCT/KR2024/007046, filed on May 24, 2024, which claims priority to Republic of Korea Patent Application No. 10-2023-0067275, filed on May 24, 2023, and Republic of Korea Patent Application No. 10-2024-0067046, filed on May 23, 2024, which are incorporated by reference herein in their entirety.

### TECHNICAL FIELD

The following embodiments relate to optimizing garment simulation parameters, and more specifically, to estimating physical property parameters for a three-dimensional (3D) simulation.

### BACKGROUND ART

In the fashion design industry, virtual simulation is widely used to develop new clothing designs. It is essential for fashion designers using virtual simulation to determine physical property parameters that represent the specific physical characteristics of actual fabrics. The current methods of obtaining physical property parameters include a method using a mechanical device to measure the properties of fabric samples, an optimization method to minimize the difference between a simulation result and a target result, a method using a learning model, and the like. Development of methods to improve the accuracy of estimating physical property parameters is needed.

### SUMMARY

With reference to embodiments described below, a method of estimating physical property parameters for three-dimensional (3D) simulation that satisfies both the speed of a learning-based neural network and the flexibility of an optimization method may be provided. However, the technical aspects are not limited to the aforementioned aspects, and other technical aspects may be present.

A method of estimating physical property parameters for drape simulation of a virtual fabric according to an embodiment includes generating, by applying physical property parameters corresponding to the virtual fabric to a neural network, which is trained on a correlation between the physical property parameters and a mesh in a state in which the virtual fabric is draped on an object, the mesh, obtaining, based on the mesh, simulated drape data corresponding to a type of target data related to a drape of the virtual fabric, and updating the physical property parameters based on an error between the obtained simulated drape data and the target data.

The physical property parameters may be obtained by updating the physical property parameters based on an optimizer for determining a value of the physical property parameters that reduces the error.

The generating of the mesh may include obtaining a latent vector corresponding to the physical property parameters from a regressor of the neural network and generating the mesh corresponding to the latent vector, based on a decoder of the neural network.

The error may include at least one of an error corresponding to a difference in a three-dimensional (3D) shape of a boundary curve between the target data and the simulated drape data, an error corresponding to a difference in a two-dimensional (2D) shape of the boundary curve between the target data and the simulated drape data, an error corresponding to a difference in a depth image matrix between the target data and the simulated drape data, and an error corresponding to a difference in reference points between the target data and the simulated drape data.

The method of estimating physical property parameters for drape simulation of a virtual fabric may further include obtaining the physical property parameters based on the target data input by a user.

The type of target data may include at least one of a type of 3D scan data related to the drape of the virtual fabric, a type of 2D image data related to the drape of the virtual fabric, a type of sketch data related to the drape of the virtual fabric, a type of depth image data related to the drape of the virtual fabric, and a type of numerical data related to the drape of the virtual fabric.

The target data may include at least one of CIR-shape drape data, SQR-shape drape data, and CAP-shape drape data.

The physical property parameters may include at least one of a parameter related to stretch stiffness and a parameter related to bending stiffness.

The parameter related to stretch stiffness may include a first parameter and a second parameter related to a factor of a stretch coefficient function, a weft direction parameter, a warp direction parameter, and a bias direction parameter of each of the first parameter and the second parameter.

The parameter related to bending stiffness may include a third parameter and a fourth parameter related to a factor of a bending coefficient function, a weft direction parameter, a warp direction parameter, and a bias direction parameter of each of the third parameter and the fourth parameter.

The method of estimating physical property parameters for drape simulation of a virtual fabric may further include generating a drape simulation result of the virtual fabric based on the updated physical property parameters.

An electronic device for estimating physical property parameters for drape simulation of a virtual fabric according to an embodiment includes a processor configured to generate, by applying physical property parameters corresponding to the virtual fabric to a neural network, which is trained on a correlation between the physical property parameters and a mesh in a state in which the virtual fabric is draped on an object, the mesh, obtain, based on the mesh, simulated drape data corresponding to a type of target data related to a drape of the virtual fabric, and update the physical property parameters based on an error between the obtained simulated drape data and the target data.

### BRIEF DESCRIPTION OF DRAWINGS

FIG. 1 is a flowchart illustrating a method of estimating physical property parameters for a drape simulation of a virtual fabric, according to an embodiment.

FIG. 2 is a diagram illustrating a structure of a system for estimating physical property parameters, according to an embodiment.

FIGS. 3A and 3B are diagrams illustrating physical property parameter values determined as a result of optimizing a set of physical property parameters corresponding to similar target drapes, according to an embodiment.

FIGS. 4A to 4C are diagrams for illustrating examples of different types of drape shapes, according to an embodiment.

FIG. 5 is a diagram for illustrating a specific structure and learning method of a simulation prediction model, according to an embodiment.

FIGS. 6A and 6B are graphs of a reconstruction error and a regression error, respectively, according to a number of pieces of training data.

FIGS. 7A to 7C are diagrams illustrating target data, according to an embodiment.

FIG. 8 is a diagram illustrating a configuration of an apparatus, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

With regard to the description of the drawings, similar reference numerals may be used to refer to similar or related components. It is to be understood that a singular form of a noun corresponding to an item may include one or more of the item, unless the relevant context clearly indicates otherwise.

As used herein, each of “A or B,” “at least one of A and B,” “at least one of A or B,” “A, B, or C,” “at least one of A, B, and C,” “at least one of A, B, or C,” “one or a combination or two or more of A, B, and C,” and the like may include any one of the items listed together in the corresponding one of the phrases, or all possible combinations thereof.

Terms such as “first,” “second,” “first,” or “second” may be used simply to distinguish one component from another and may not limit the components with respect to other aspects (e.g., importance or order). For example, a first component may be referred to as a second component, and similarly, the second component may also be referred to as the first component.

It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

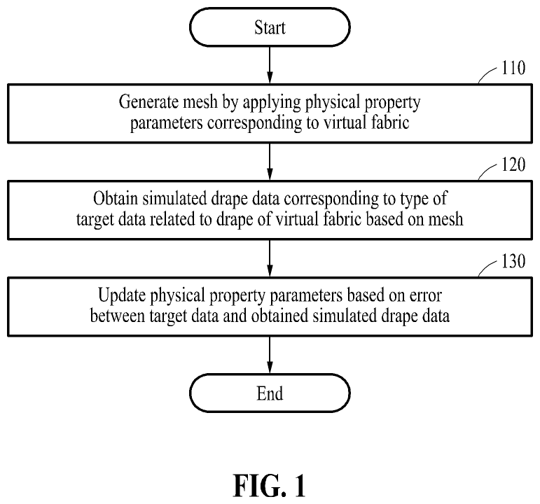

FIG. 1 is a flowchart illustrating a method of estimating physical property parameters for a drape simulation of a virtual fabric, according to an embodiment. Referring to FIG. 1, a method of estimating physical property parameters may include operation 110 of generating a mesh by applying physical property parameters corresponding to a virtual fabric to a neural network. The virtual fabric may correspond to a virtual representation of an existing fabric.

The physical property parameters are related to physical properties that appear in a fabric (or cloth or textile) or are capable of being measured in a fabric. For example, the physical property parameters may include parameters used in virtual simulation to reproduce the physical properties of an actual fabric. For example, the physical property parameters may include at least one of a parameter related to stretch stiffness and a parameter related to bending stiffness. The stretch stiffness may be a numerical expression of a strength of a fabric to resist a tensile load (or a force to stretch the fabric). The bending stiffness may be a numerical expression of a strength of a fabric to resist a bending load (or a force to bend the fabric). Specific examples of the physical property parameters are described in detail below.

A method of estimating physical property parameters may include obtaining physical property parameters based on target data, which is related to a drape of the virtual fabric, received as a user input. An initial value of the physical property parameters may be determined based on the target data. For example, the initial value of the physical property parameters is obtained by measuring the physical property parameters of the target data by a measuring apparatus.

The target data may include information on the fabric of the virtual fabric or information on the drape of the virtual fabric. For example, the target data may include at least one of three-dimensional (3D) scan data related to the drape of the virtual fabric, two-dimensional (2D) image data related to the drape of the virtual fabric, sketch data related to the drape of the virtual fabric, depth image data related to the drape of the virtual fabric, and numerical data related to the drape of the virtual fabric. Specifically, the target data may be data obtained experimentally on various data corresponding to an arbitrary fabric. More specifically, the target data may be data confirming a result of draping the arbitrary fabric on an object.

The 3D scan data related to the drape of the virtual fabric may include data obtained by 3D-scanning a shape of the actual fabric placed on an object. The 2D image data related to the drape of the virtual fabric may include 2D image data obtained by projecting the shape of the actual fabric placed on an object onto a specific plane (e.g., a top view and a front view). The sketch data related to the drape of the virtual fabric may include data outlining the shape of the actual fabric placed on an object. The depth image data related to the drape of the virtual fabric may include data including depth information of the shape of the actual fabric placed on an object obtained from a depth sensor. The numerical data related to the drape of the virtual fabric may be numerical data to represent the shape of the actual fabric placed on an object and may include data related to the size of the fabric, the size of an area of the fabric that touches the object, a distance from a floor to a vertex of the fabric, and the like.

According to one embodiment, the target data of at least one of the aforementioned types may be provided by the user. Alternatively, the target data of at least one of the aforementioned types may be generated based on the user input (for example, using a generative model or the like).

A processor may obtain one or more physical property parameters matching the target data. The processor may obtain the physical property parameters from a database in the form of a lookup table, or by processing (for example, interpolating) information stored in the database. Alternatively, the processor may be set to infer the physical property parameters matching the target data using a pre-trained neural network.

For example, a drape simulation result of the virtual fabric applied with initial value sof the physical property parameters may not be sufficiently similar to an actual drape result of a fabric. Accordingly, initial physical property parameters may be updated by operations 120 and 130 described below. Updates of the physical property parameters may be performed repeatedly; that is, operations 110, 120, and 130 may be repeatedly performed using the updated physical property parameters. Based on the updated physical property parameters, the processor may generate the drape simulation result of the virtual fabric.

The neural network may include a neural network that is trained on correlation between the physical property parameters and the mesh representing a virtual fabric draped (or placed) on an object. The object is a predefined object used for simulating draping of fabrics. The object may be, but is not limited to, a 3D cylinder. The object may have various shapes other than a cylindrical shape. In another example, the object may be a 3D avatar. The neural network may be trained to generate a mesh corresponding to the shape of the virtual fabric draped on the object. A specific structure and training method of the neural network are described in detail below.

A method of estimating physical property parameters may include operation 120 of obtaining simulated drape data corresponding to a type of target data related to the drape of the virtual fabric based on the mesh. The target data may be data corresponding to a drape shape of the virtual fabric that is a target of the drape simulation result of the virtual fabric generated based on the physical property parameters. The simulated drape data may be drape data simulating the use of a spring mass model based on the mesh. That is, the simulated drape data for the virtual fabric may be drape data for the virtual fabric that corresponds to the drape data obtained when the actual fabric is draped on the object.

For example, the type of target data may include at least one of a type of 3D scan data related to the drape of the virtual fabric, a type of 2D image data related to the drape of the virtual fabric, a type of sketch data related to the drape of the virtual fabric, a type of depth image data related to the drape of the virtual fabric, and a type of numerical data related to the drape of the virtual fabric.

The simulated drape data corresponding to the type of target data may correspond to data of the type of target data extracted from a mesh generated by a neural network. For example, when the type of target data is the type of 3D scan data related to the drape of the virtual fabric, 3D data illustrating a shape of the virtual fabric may be extracted from the mesh. For example, when the type of target data is 2D image data related to the drape of the virtual fabric or the type of sketch data related to the drape of the virtual fabric, 2D data may be obtained by projecting the shape of the virtual fabric obtained from the mesh onto a plane corresponding to the target data. For example, when the type of target data is depth image data related to the drape of the virtual fabric, depth image data of the virtual fabric may be extracted from the mesh. For example, when the type of target data is numerical data related to the drape of the virtual fabric, numerical data included in the target data may be extracted from the mesh.

For example, the target data may include at least one of circular (CIR)-shape drape data, square (SQR)-shape drape data, and capelet (CAP)-shape drape data. A CIR shape, an SQR shape, and a CAP shape may be types of drape shape and are described in detail below.

A method of estimating physical property parameters may include operation 130 of updating physical property parameters based on an error between the obtained simulated drape data and the target data. Operation 130 of updating physical property parameters may include determining a value of optimized physical property parameters. The value of the optimized physical property parameters may include a value of physical property parameters that match a shape of a fabric indicated by the target data.

Operation 130 of updating physical property parameters may include updating physical property parameters based on an optimizer for determining a value of physical property parameters that reduces an error.

The error may be represented as an error function for optimization. The error may be determined based on a difference in shape between the target data and the simulated drape data. For example, the error may include at least one of an error corresponding to a difference in a 3D shape of a boundary curve between the target data and the simulated drape data, an error corresponding to a difference in a 2D shape of the boundary curve between the target data and the simulated drape data, an error corresponding to a difference in a depth image matrix between the target data and the simulated drape data, and an error corresponding to a difference in reference points between the target data and the simulated drape data. An optimization operation based on an error is described in detail below.

A method of estimating physical property parameters may include generating a drape simulation result of a virtual fabric based on updated physical property parameters. The processor may generate a drape simulation result of the virtual fabric corresponding to the physical property parameters determined by optimization. That is, the processor may generate the drape simulation result of the virtual fabric corresponding to the target data. The drape simulation result of the virtual fabric may include 3D data of the drape shape of the fabric indicated by the target data. The drape shape of the fabric may refer to a shape of the fabric draped on the object. For example, the drape simulation result of the virtual fabric may include 3D graphic data of the drape shape of the fabric. For example, the 3D graphic data may be output through an interface.

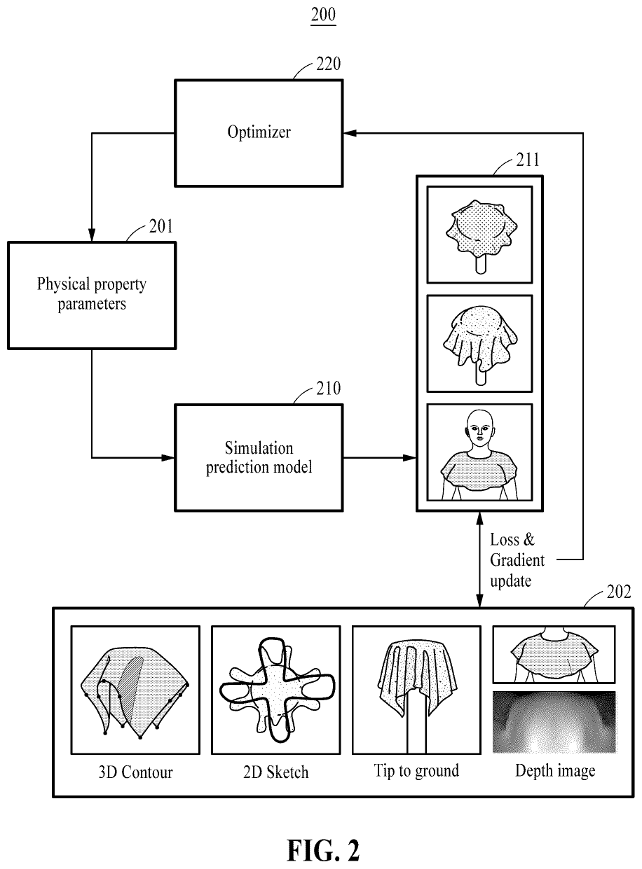

FIG. 2 is a diagram illustrating a structure of a system for estimating physical property parameters, according to an embodiment. Referring to FIG. 2, system 200 may performs the method of estimating physical property parameters 201 described above with reference to FIG. 1. The physical property parameters 201 provided to the system 200 may include at least one parameter associated with a physical characteristic (hereinafter referred to as “physical parameter”). The system 200 may simulate a result using a pre-trained neural network of a simulation prediction model 210 to optimize the physical property parameters 201, which may be simulation parameters, and reconstruct drape data 211 of a virtual fabric. The drape data 211 of the virtual fabric reconstructed from the estimated simulation result may indicate a shape of a simulated drape. The drape data 211 of the virtual fabric reconstructed from the estimated simulation result is referred to as simulated drape data or a simulated drape. The reconstructed drape data 211 of the virtual fabric may be compared to the target data based on various physical property parameters 201, and an objective function may be freely designed according to the needs of a user.

Target data 202 provided to the system 200 may include various types of data, including at least one of 3D scan information (e.g., a 3D contour) of a drape shape of an actual fabric, a 2D silhouette image (e.g., a 2D sketch), vertex height (e.g., tip to ground) data of a draped fabric, and a depth image. For example, the 3D scan information of the drape shape of the actual fabric may correspond to the 3D scan data related to the drape of the virtual fabric described above. The 2D silhouette image may correspond to the 2D image data related to the drape of the virtual fabric described above. The vertex height data of the draped fabric may correspond to the numerical data related to the drape of the virtual fabric described above.

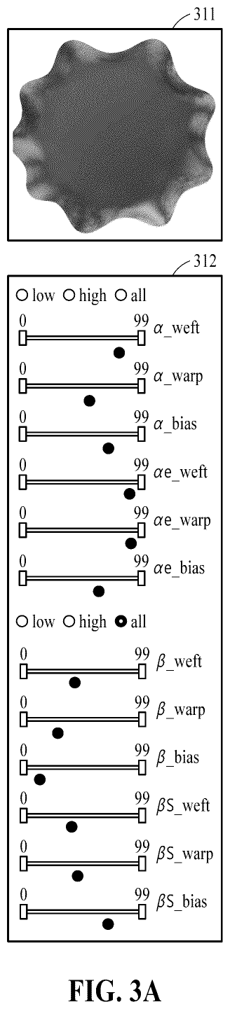

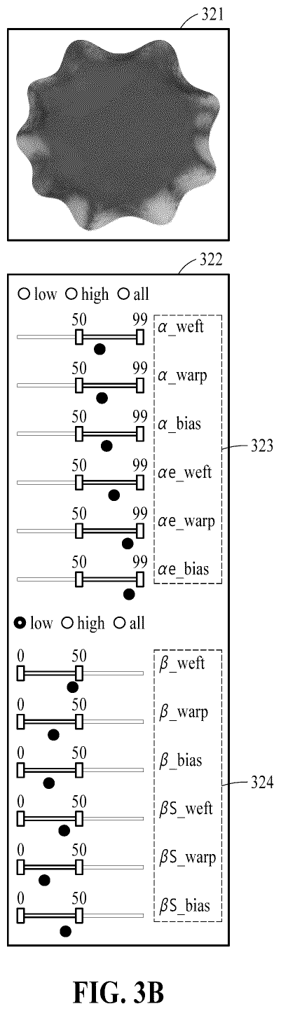

The physical property parameters 201 may be converged to an optimization result within seconds to minutes through the system 200. In addition, by specifying different ranges of the physical property parameters 201 through the system 200, the system 200 may obtain a plurality sets of the physical property parameters 201 that may generate the same or similar drape simulation result of the virtual fabric. For example, FIGS. 3A and 3B illustrate a value of physical property parameters determined as a result of optimizing a set of physical property parameters corresponding to similar target drapes. Referring to a screen 312 of FIG. 3A displaying a range and value of a set of physical property parameters, the range and value of each physical property parameter included in the set of physical property parameters may be specified in the range from 0 to 99. The processor may determine a value of physical property parameters within the range specified through optimization. The processor may be set to output a drape simulation result of the virtual fabric corresponding to the determined physical property parameters on a screen 311. Referring to a screen 322 of FIG. 3B displaying a range and value of a set of physical property parameters, the processor may set the range of a portion of physical property parameters 323 to be from 50 to 99 and the range of the other portion of physical property parameters 324 to be from 0 to 50. Accordingly, the value of physical property parameters may be determined by optimization within the specified range. The processor may be set to output a drape simulation result of the virtual fabric corresponding to the determined physical property parameters on a screen 321. The processor may obtain a plurality of sets of physical property parameters that may generate a same or similar drape simulation result of the virtual fabric.

Referring again to FIG. 2, to estimate the physical property parameters 201, the processor may be use a mesh of a simulation result estimated by the simulation prediction model 210 based on a neural network. The processor may obtain a gradient of a change in the physical property parameters 201 according to a change in the simulation result through estimating the simulation result using a neural network. The gradient of the change in the physical property parameters 201 may be used to improve the speed and accuracy of local optimization of the physical property parameters 201. The estimation of the simulation result using a neural network may have a faster operation speed than performing an actual simulation. In addition, the method of estimating physical property parameters may be applied regardless of a type of simulator. In other words, the system 200 may be applied to any type of simulator.

The simulation prediction model 210 may be a model based on a spring mass model. Backward differentiation formula (BDF)-2 implicit integration may be applied to the simulation prediction model 210. The simulation prediction model 210 may estimate a drape simulation result by considering stretch stiffness and bending stiffness, which may greatly affect a drape shape of the fabric. A stress-strain relationship may be defined as a non-linear function.

For example, a stretch coefficient function may be an exponential function of a stretched length and may be defined as Equation 1 below.

$$s ( l ) = α exp ( {α}_{e} \frac{\vert l - {l}_{0} \vert}{{l}_{0}} ) \qquad Equation 1$$

In Equation 1, α denotes a tensile base factor, and αₑ denotes a tensile growth factor related to the gradient of the function.

For example, a bending coefficient function b(θ) may be defined as Equation 2 below.

$${b}_{i} ( θ ) = \{ \begin{matrix}β & cos ( θ ) > t \\ {β}_{S} β & cos ( θ ) \leq t\end{matrix} \qquad Equation 2$$

In Equation 2, β denotes a bending strength factor, and βₛ denotes a bending scale factor. θ denotes an angle at which two adjacent mesh triangles are bent, and in a fully unfolded state, θ=0°. When bent above a certain level (e.g., cos (θ)<=t), the bending strength factor β may be reduced by βₛ that may be defined as a value from 0 to 1. Density of the fabric may also have an effect on the drape shape of the fabric. The simulation prediction model 210 may estimate the simulation result using a value obtained by dividing a stretch stiffness value by a density value. In this case, the density may be fixed as a constant. For example, the physical property parameters 201 to be estimated may be α, αₑ, β, and βₛ. The stretch stiffness and the bending stiffness may be defined as an anisotropic model that is independently defined for each of weft, warp, and bias directions. The total number of the physical property parameters 201 may be 12. The weft may be a thread of a horizontal direction of the fabric and may also be referred to as a “weft thread.” In addition, the “warp” may be a thread of a vertical direction of the fabric and is also referred to as a “warp thread.” In other words, a parameter of the physical property parameters 201 related to the stretch stiffness may include a first parameter (e.g., α) and a second parameter (e.g., αₑ) related to a factor of the stretch coefficient function and may include a weft direction parameter, a warp direction parameter, and a bias direction parameter of each of the first parameter and the second parameter. The parameter related to the stretch stiffness may include six parameters. A parameter related to the bending stiffness among the physical property parameters 201 may include a third parameter (e.g., β) and a fourth parameter (e.g., βₛ) related to a factor of the bending coefficient function and may include a weft direction parameter, a warp direction parameter, and a bias direction parameter of each of the third and fourth parameters. The parameter related to the bending stiffness may include six parameters.

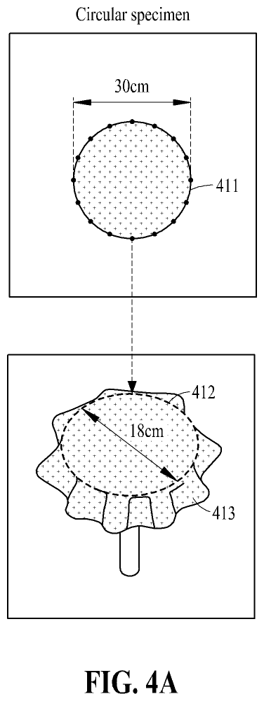

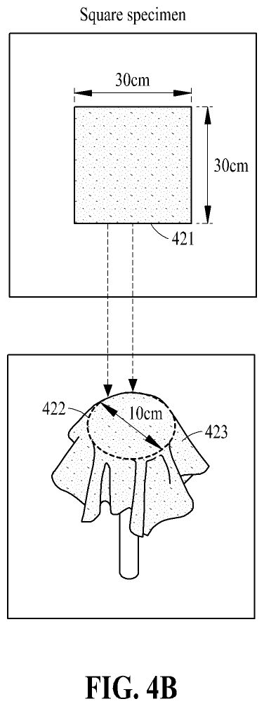

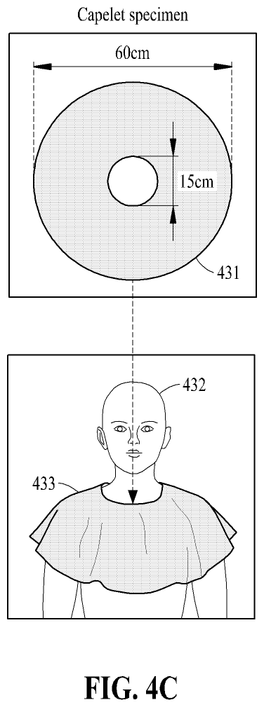

The drape shape of the target data 202 may include a CIR shape, an SQR shape, and a CAP shape. For example, referring to FIG. 4A, a CIR shape 413 may be a drape shape of a portion unsupported by an object when a circular specimen (e.g., a circular specimen having a 30-centimeter (cm) diameter) 411 is placed on a disk 412 of a cylinder, or the object. In the case of the CIR shape 413, since a width of all unsupported areas of the specimen is the same, the drape shape may not be biased by mass distribution. For example, referring to FIG. 4B, an SQR shape 423 may be a drape shape of a portion unsupported by an object when a square specimen (e.g., a square specimen with a 30 cm edge) 421 is placed on a disk 422 of a cylinder, or the object. The square specimen 421 may be advantageous for distinguishing between weft and warp directions compared to specimens of other shapes. Referring to FIG. 4C, a CAP shape 433 may be a drape shape when a capelet specimen 431, or a donut-shaped specimen (e.g., a circular specimen that is 60 cm in diameter, with a 15 cm diameter circular hole in the center) is placed on a human body 432, or the object.

Referring again to FIG. 2, a sufficient amount of data on the actual fabric may be used to generate training data for the simulation prediction model 210. For example, optimized physical property parameters for 5,000 different actual fabrics may be obtained as the training data from a random garment simulator (e.g., CLO3D). Physical parameter data may be classified into “k” clusters using a Gaussian mixture model (GMM), and sampling of a same size may be performed on each cluster. For example, by setting k=5 and sampling 60,000 pieces of data for each cluster, physical property parameter data for a total of 300,000 fabrics may be obtained. The result of performing simulation for specimens of three types (e.g., CIR, SQR, and CAP) of drape shapes on each physical property parameter sample may be saved as a mesh. The specimen used in the simulation may be made of a triangular mesh randomly sampled so that maximum vertex spacing is a preset value. For example, the specimen may be made of a triangular mesh randomly sampled with a vertex spacing of less than 5 mm for the CIR and the SQR shapes and less than 10 mm for the CAP shape. A number of vertices (or triangles) of the specimens may be 5,148 (or 10,102) for the CIR shape, 6,563 (or 12,880) for the SQR shape, and 4,890 (or 37,930) for the CAP shape. A simulation time step may be set to 0.03 seconds.

The simulation prediction model 210 may include a neural network that predicts a drape mesh, which may be a drape simulation result for specific physical property parameters 201.

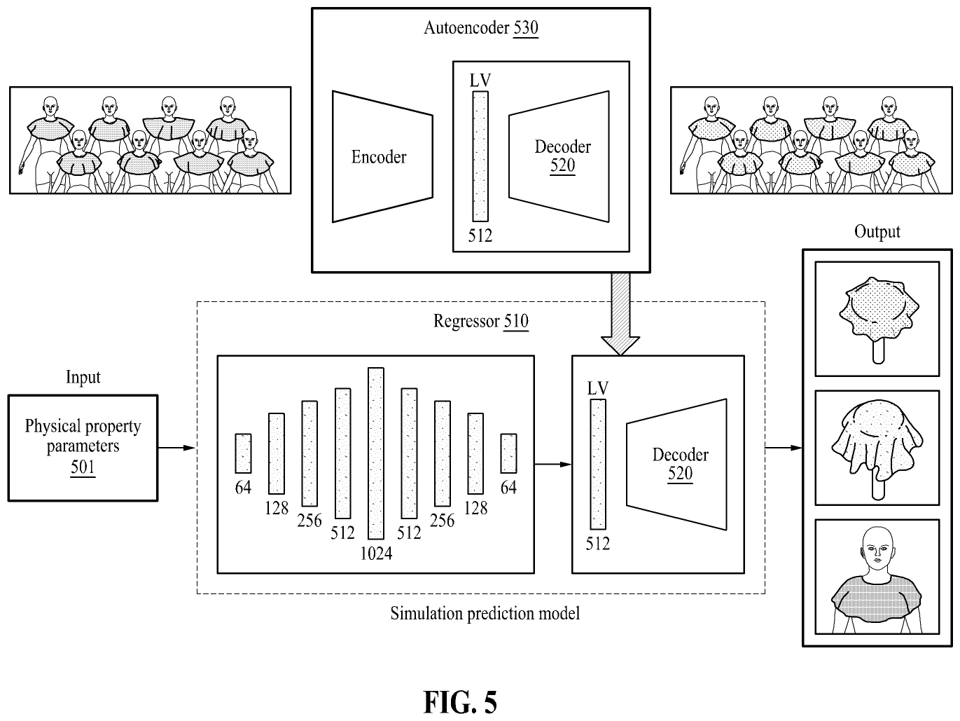

Referring to FIG. 5, a specific structure and training of the simulation prediction model 210 are described. Referring to FIG. 5, the simulation prediction model 210 may include a regressor 510 and a decoder 520. The regressor 510 of the simulation prediction model 210 may estimate a latent vector of a simulated mesh from input physical property parameters 501. For example, the latent vector may be a 512-dimensional vector. The decoder 520 may decode the estimated latent vector to restore a drape mesh.

An autoencoder 530 may be used to extract the latent vector LV. The decoder 520 of the simulation prediction model 210 may be a decoder of the autoencoder 530. The autoencoder 530 may include a mesh structure-specific convolutional neural network (e.g., SpiralNet++) that may encode a mesh structure while maintaining a mesh structure. A latent vector of a certain size (e.g., 512 dimensions) may be extracted for the three types of drape shapes.

The simulation prediction model 210 may include the regressor 510, which is a regression model. For example, the regressor 510 may include a multi-layer perceptron (MLP) regression model to estimate a relationship between the physical property parameters 501 and the latent vector. For example, the regressor 510 may include nine hidden layers with 64, 128, 256, 512, 1024, 512, 256, 128, and 64 hidden units, respectively. A ReLU activation function may be included between each layer.

The autoencoder 530 may be trained using simulated drape meshes as training data. The trained autoencoder 530 may be used to encode the simulated drape mesh of all training data and extract the latent vector. Thereafter, the regressor 510 may be trained using the latent vector.

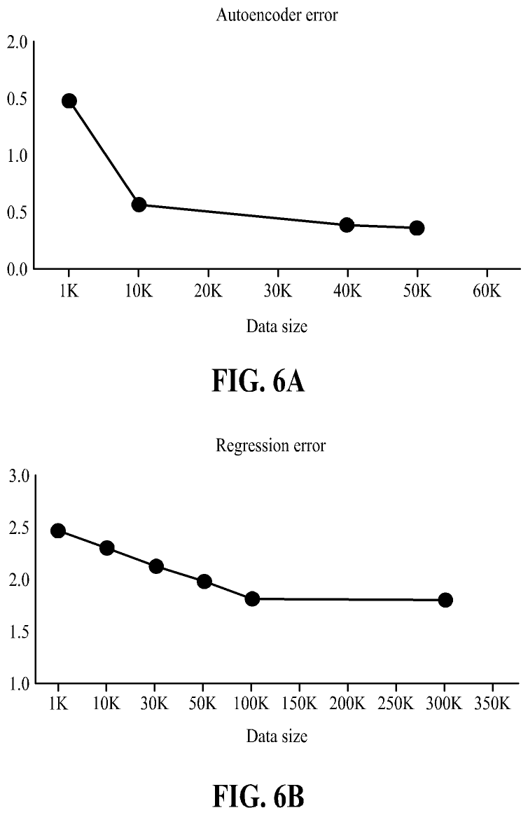

For example, a randomly selected portion of the training data (e.g., 40,000 pieces of training data) may be used for training of the autoencoder 530. All of the training data (e.g., 300,000 pieces of training data) may be used for training of the regressor 510. For example, the graph of FIG. 6A and the graph of FIG. 6B respectively show a reconstruction error and a regression error according to the number of training data. The reconstruction error of the autoencoder 530 was already sufficiently low when trained with 40,000 pieces of training data, and there was no significant change in the error when training was performed with more data. On the contrary, in the training of the regressor, the regression error may continue to decrease as the number of pieces of training data increases. By the above, it may be confirmed that diversity of physical property parameters is higher than diversity of drape shapes and that a relationship between physical property parameters and drape shape is many-to-one.

Referring again to FIG. 2, an optimizer 220 may be a model for finding the optimal physical property parameters 201 (e.g., P*) that reduces an error between a target drape and the simulated drape. The target drape may refer to a drape included in the target data 202. The simulated drape may refer to a drape included in the drape data 211 extracted from the mesh obtained by the simulation prediction model 210. The simulated drape may refer to the simulated drape data described above. An optimization problem may be defined as Equation 3 below.

$${P}^{*} = {arg min}_{P} E ( 𝒯 , Sim ( P ) ) \qquad Equation 3$$

$$s . t . P ∈ 𝒟 ,$$

In Equation 3, P denotes the physical property parameters 201, [symbol] denotes the target drape included in the target data 202, and Sim(·) denotes the simulation prediction model 210. E(·) denotes an error function representing a difference between the target drape and an estimated simulated drape with respect to the physical property parameters 201 P. D denotes a domain condition defined by a user. A set of physical property parameters 201 that produce one drape shape may be assumed not to be unique. Bound-constrained global optimization may be used to find different results according to the condition specified by the user. For example, a dual annealing algorithm may be used for global optimization. Dual annealing may be adopted as one of metaheuristic optimization algorithms to solve a global optimization problem. A processor may use dual annealing to reduce a nonlinear and irregular objective function. In particular, dual annealing may start from a high energy state and gradually converge to a low energy state in a process of searching a parameter space to optimize the objective function and may combine a metaheuristic search method and sampling. Dual annealing may effectively search the parameter space through a metaheuristic algorithm and random sampling, and the processor may adaptively set a plurality of hyperparameters, which may affect a convergence speed or optimization performance in the process of the search through dual annealing, to optimize the model of the present disclosure. For example, an L-BFGS-B algorithm may be used for local optimization. Local optimization may be performed using a gradient obtained by backpropagation of an optimization neural network.

Four error functions that may be used independently or together for training of the optimization neural network may be defined.

The physical property parameters 201 may be estimated from a 3D boundary curve of the SQR-shape drape. As shown in Equation 4 below, a difference in a shape of a boundary curve between the target drape and the simulated drape may be defined as a first error function E_{B3}.

$${E}_{B 3} = ( 1 - ω ( t ) ) {\sum }_{i ∈ Θ} {‖ {v}_{i} - {v}_{i}^{*} ‖}^{2} + ω ( t ) {\sum }_{i ∈ Ω} {‖ {v}_{i} - {v}_{i}^{*} ‖}^{2} \qquad Equation 4$$

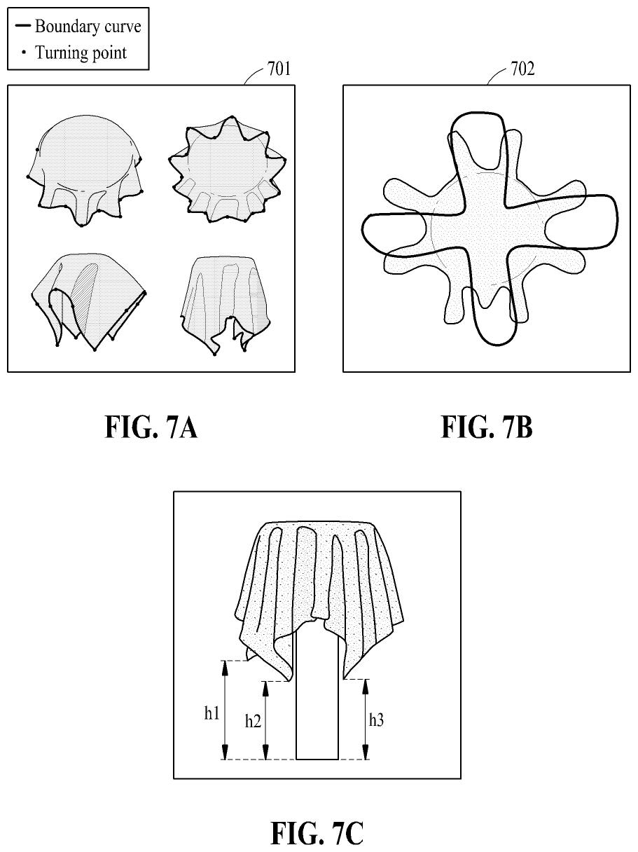

In Equation 4, vᵢ* and vᵢ denote an i-th vertex of the target drape and the simulated drape, respectively. Θ denotes a set of indices of all sampling points on the boundary curve. Ω denotes a set of indices of the turning points of the boundary curve of the target drape. For example, referring to FIG. 7A, target data may include 3D scan data 701 related to a drape of a virtual fabric indicating the boundary curve and the turning point of the target drape.

In Equation 4, ω(t) denotes a weight function that decreases as time t passes. For example, ω(0)=0.9 may be initially set, and co may decrease by 0.99% every 100 evaluations of the objective function. At the beginning of the optimization, the weight may be set high for matching a number and a location of the turning points of the boundary curve, and as the optimization progresses, the weight may be set high for matching the shape of the entire drape.

A difference in the shape of a 2D boundary curve between the target drape and the simulated drape may be defined as a second error function. The second error function E_{B2} may be defined from the first error function E_{B3} by projecting 3D points onto a 2D plane. For example, the 2D boundary curve of the drape observed from a top view may be recorded using a rotoscope. For example, the 2D boundary curve may be drawn by the user. For example, referring to FIG. 7B, the target data may include sketch data 702 of the boundary curve of a CAP-shape drape projected in a front view. The sketch data 702 of FIG. 7B may be an example of the sketch data related to the drape of the virtual fabric described above.

The target data 202 of a sketch data type may be used when digital scan or photography of an actual drape is difficult. In addition, when an actual fabric does not exist, the target data 202 of a sketch data type may be used as the target data 202 for estimating the physical property parameters 201 by drawing a drape shape that a designer knows empirically.

Depth images taken from multiple directions may be used as target data for an SQR-shape drape. The depth image may include data related to an overall shape of the target drape and may be used even when it is difficult to record the boundary curve of the target drape accurately. A third error function ED for the depth image may be defined as Equation 5 below.

$${E}_{D} = {\sum }_{i = 1}^{n} {\sum }_{j = 1}^{m} \vert {[ {I}_{k} - {I}_{k}^{*} ]}_{ij} \vert , \qquad Equation 5$$

In Equation 5, I*ₖ and Iₖ denote matrices of a k-th depth image of the target drape and the simulated drape, respectively. There may be more than one depth image. For example, four depth images with 256×256 pixel resolution taken from different directions may be used.

When manually adjusting the physical property parameters 201, there are reference points that expert designers consider important. Referring to FIG. 7C, when draping a square specimen such as an SQR shape, heights of four corners (e.g., h1, h2, and h3) may correspond to the reference points. In a case of a T-shirt, the degree to which a round line of a front and back of a neckline are bent downward may also correspond to the reference points. A fourth error function E_{L} related to the reference points may be defined as Equation 6 below.

$${E}_{L} = {\sum }_{i = 1}^{4} {‖ {l}_{i} - {l}_{i}^{*} ‖}^{2} \qquad Equation 6$$

In Equation 6, l*ᵢ and lᵢ denote the length of an i-th reference point in the target drape and in the simulated drape, respectively.

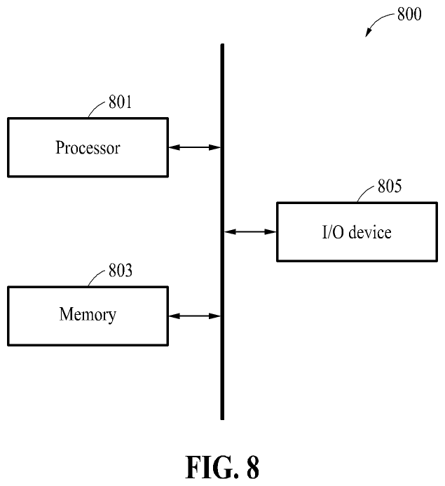

FIG. 8 is a diagram illustrating the configuration of an apparatus, according to one embodiment. Referring to FIG. 8, a device 800 may include a processor 801, a memory 803, and an input/output (I/O) device 805. The electronic device 800 may include a device for performing the method of estimating physical property parameters described above with reference to FIGS. 1 to 7.

The processor 801 may perform at least one operation related to the method of estimating physical property parameters described above with reference to FIGS. 1 to 7. For example, the processor 801 may perform at least one of generating a mesh by applying physical property parameters corresponding to a virtual fabric to a neural network, obtaining, based on the mesh, drape data corresponding to a type of target data related to a drape of the virtual fabric, and updating the physical property parameters based on an error between the obtained drape data and the target data.

The memory 803 may be a volatile memory or a non-volatile memory and may store data related to the method of estimating physical property parameters described above with reference to FIGS. 1 to 7. For example, the memory 803 may store data generated in the process of performing the method of estimating physical property parameters or data necessary to perform the method of estimating physical property parameters. For example, the memory 803 may store updated physical property parameters and may store weight(s) and parameter(s) between layers included in the neural network and/or the optimizer of the trained simulation prediction model.

The memory 803 may store a program in which the method of estimating physical property parameters described above with reference to FIGS. 1 to 7 is implemented. The processor 801 may execute a program stored in the memory 803 and may control the electronic device 800. Code of the program executed by the processor 801 may be stored in the memory 803.

The electronic device 800 may receive data from a user through the I/O device 805 and output generated data. For example, the electronic device 800 may receive the target data through the I/O device 805 and output a simulation result of a virtual fabric generated based on determined physical property parameters or a value of the determined physical property parameters. The electronic device 800 may be connected to an external device (e.g., a personal computer (PC) or a network) through the I/O device 805 and exchange data with the external device.

The electronic device 800 may further include other components not shown in the drawings. For example, the electronic device 800 may include a communication module that provides a function for the electronic device 800 to communicate with another electronic device or another server through a network. In addition, for example, the electronic device 800 may further include other components such as a transceiver, various sensors, and a database.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, a different processing configuration is possible, such as one including parallel processors.

The software may include a computer program, a piece of code, an instruction, or one or more combinations thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as floptical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of estimating physical property parameters for drape simulation of a virtual fabric, the method comprising:
generating, by applying physical property parameters corresponding to the virtual fabric to a neural network, which is trained on a correlation between the physical property parameters and a mesh in a state in which the virtual fabric is draped on an object;
obtaining, based on the mesh, simulated drape data corresponding to a type of target data related to a drape of the virtual fabric; and
updating the physical property parameters based on an error between the obtained simulated drape data and the target data.

2. The method of claim 1, wherein the updating of the physical property parameters comprises:
updating the physical property parameters based on an optimizer for determining a value of the physical property parameters that reduces the error.

3. The method of claim 1, wherein the generating of the mesh comprises:
obtaining a latent vector corresponding to the physical property parameters from a regressor of the neural network; and
generating the mesh corresponding to the latent vector, based on a decoder of the neural network.

4. The method of claim 1, wherein the error comprises at least one of:
an error corresponding to a difference in a three-dimensional (3D) shape of a boundary curve between the target data and the simulated drape data;
an error corresponding to a difference in a two-dimensional (2D) shape of the boundary curve between the target data and the simulated drape data;
an error corresponding to a difference in a depth image matrix between the target data and the simulated drape data; and
an error corresponding to a difference in reference points between the target data and the simulated drape data.

5. The method of claim 1, further comprising:
obtaining the physical property parameters based on the target data received from a user.

6. The method of claim 1, wherein the type of target data comprises at least one of:
a type of three-dimensional (3D) scan data related to the drape of the virtual fabric;
a type of two-dimensional (2D) image data related to the drape of the virtual fabric;
a type of sketch data related to the drape of the virtual fabric;
a type of depth image data related to the drape of the virtual fabric; and
a type of numerical data related to the drape of the virtual fabric.

7. The method of claim 1, wherein the target data comprises at least one of CIR-shape drape data, SQR-shape drape data, and CAP-shape drape data.

8. The method of claim 1, wherein the physical property parameters comprise:
at least one of a parameter related to stretch stiffness and a parameter related to bending stiffness.

9. The method of claim 8, wherein the parameter related to stretch stiffness comprises:
a first parameter and a second parameter related to a factor of a stretch coefficient function; and
a weft direction parameter, a warp direction parameter, and a bias direction parameter of each of the first parameter and the second parameter.

10. The method of claim 8, wherein the parameter related to bending stiffness comprises:
a third parameter and a fourth parameter related to a factor of a bending coefficient function; and
a weft direction parameter, a warp direction parameter, and a bias direction parameter of each of the third parameter and the fourth parameter.

11. The method of claim 1, further comprising:
generating a drape simulation result of the virtual fabric based on the updated physical property parameters.

12. A non-transitory computer-readable storage medium storing instructions that, when executed by one or more processors, cause the one or more processors to:
generate, by applying physical property parameters corresponding to a virtual fabric to a neural network, which is trained on a correlation between the physical property parameters and a mesh in a state in which the virtual fabric is draped on an object;
obtain, based on the mesh, simulated drape data corresponding to a type of target data related to a drape of the virtual fabric; and
update the physical property parameters based on an error between the obtained simulated drape data and the target data.

13. An electronic device for estimating physical property parameters for drape simulation of a virtual fabric, comprising a processor configured to:
generate, by applying physical property parameters corresponding to the virtual fabric to a neural network, which is trained on a correlation between the physical property parameters and a mesh in a state in which the virtual fabric is draped on an object;
obtain, based on the mesh, simulated drape data corresponding to a type of target data related to a drape of the virtual fabric; and
update the physical property parameters based on an error between the obtained simulated drape data and the target data.
